(19) United States
(12) Patent Application Publication
(10) Pub. No.: US 2026/0134614 A1
(43) Pub. Date: May 14, 2026

(54) REAL-TIME VIEW SYNTHESIS

(71) Applicant: GOOGLE LLC, Mountain View, CA (US)

(72) Inventors: Ryan Styles Overbeck, Mountain View, CA (US); Michael Joseph Broxton, Los Gatos, CA (US); Lukas Murmann, San Mateo, CA (US); John Patrick Flynn, Los Angeles, CA (US); Daniel William Erickson, Oakland, CA (US)

(21) Appl. No.: 19/118,110

(22) PCT Filed: Nov. 15, 2023
(86) PCT No.: PCT/US2023/079864

§ 371 Date: Apr. 3, 2025

Related U.S. Application Data
(60) Provisional application No. 63/383,866, filed on Nov. 15, 2022.

(51) Int. Cl. G06T 15/20; G06T 3/40; G06T 15/08; G06T 17/20

(52) U.S. Cl. CPC G06T 15/205; G06T 3/40; G06T 15/08; G06T 17/20

(57) ABSTRACT

A method including receiving a plurality of two-dimensional (2D) images representing a frame of a streaming three-dimensional (3D) video, generating a plurality of meshes corresponding to one of the plurality of 2D images, generating a synthesized mesh based on the plurality of meshes, generating a left-eye 3D image and depth based on the synthesized mesh, and generating a right-eye 3D image and depth map based on the synthesized mesh, the left-eye 3D image and depth map and the right-eye 3D image and depth map having a viewpoint perspective based on a receiver of the streaming 3D video.

### CROSS-REFERENCE TO RELATED APPLICATION

This application claims the benefit of U.S. Provisional Application No. 63/383,866, filed on Nov. 15, 2022, the disclosure of which is incorporated herein by reference in its entirety.

### FIELD

Embodiments relate to rendering three-dimensional left-eye and right-eye images.

### BACKGROUND

Generating a three-dimensional (3D) image from a plurality of two-dimensional (2D) images can involve stitching of the 2D images. A stitching operation can include computing all possible translations (x, y, z) between two 2D images with relation to a 3D perspective simultaneously. Computing the translations can determine the best overlap with regard to a cross-correlation measure. If more than two input images are used the correct placement of portions of the images (sometimes called tiles) can be globally optimized (e.g., the resultant 3D image is modified to remove gaps and overlaps).

### SUMMARY

Example implementations describe a neural rendering and view synthesis system configured to synthesize two viewpoints (e.g., left-eye and right-eye) based on the eye positions of a receiver-side viewer of a streaming sequence of 3D images. The 3D images can be synthesized as a layered mesh based on a plurality of 2D images and rendered prior to streaming the sequence of 3D images. The layered mesh can be used to render any potential viewpoint perspective of a user viewing a 3D image using a playback device.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of the example embodiments and wherein:

FIG. 1 illustrates a block diagram of a streaming pipeline according to an example implementation.

FIG. 2 illustrates a block diagram of a view synthesis system according to an example implementation.

FIG. 3 illustrates a block diagram of a neural rendering system according to an example implementation.

FIG. 4A illustrates a block diagram of an example machine learning downsampling network according to an example implementation.

FIG. 4B illustrates a block diagram of an example machine learning view synthesis network according to an example implementation.

FIG. 4C illustrates a block diagram of an example machine learning upsampling network according to an example implementation.

FIG. 5 illustrates a block diagram of a system according to an example implementation.

FIG. 6 illustrates a block diagram of a method according to an example implementation.

It should be noted that these Figures are intended to illustrate the general characteristics of methods, and/or structures utilized in certain example embodiments and to supplement the written description provided below. These drawings are not, however, to scale and may not precisely reflect the precise structural or performance characteristics of any given embodiment and should not be interpreted as defining or limiting the range of values or properties encompassed by example embodiments. For example, the positioning of modules and/or structural elements may be reduced or exaggerated for clarity. The use of similar or identical reference numbers in the various drawings is intended to indicate the presence of a similar or identical element or feature.

### DETAILED DESCRIPTION

Generating a 3D image by stitching a plurality of 2D images is not sufficiently fast for real-time streaming of 3D images. In other words, capturing and stitching 2D images in a real-time 3D streaming application is too slow to provide the desired user experience. Existing solutions may reduce the resolution (e.g., number of pixels) to a very low resolution, and still may not achieve the framerate or frames per second (fps) desired for real-time streaming of 3D images.

Example implementations can use a trained machine learning model for synthesizing a 3D mesh from a plurality of 2D images. Example implementations can further use a trained machine learning model to render the synthesized 3D mesh to generate two 3D images each with a viewpoint perspective (e.g., left-eye and right-eye). The 3D images can then be streamed to a 3D playback device. Example implementations can stream the 3D images at a sufficiently high resolution (e.g., 4K) and framerate (e.g., 30 fps) in a real-time 3D streaming application to provide the desired user experience.

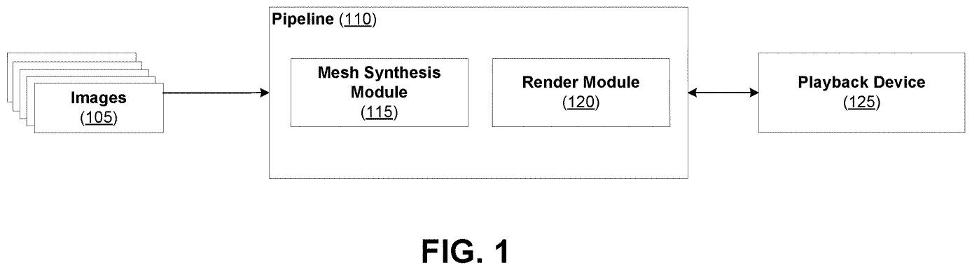

FIG. 1 illustrates a block diagram of a 3D streaming pipeline according to an example implementation. As shown in FIG. 1, a 3D streaming pipeline 110 can include a mesh synthesis module 115 and a render module 120. The 3D streaming pipeline 110 can be configured to receive a plurality of 2D images 105 and generate two 3D images that can be streamed to a playback device 125.

A plurality of cameras (e.g., a camera rig) can be configured to capture the plurality of 2D images 105. In an example implementation, the plurality of cameras (e.g., six cameras) can be rolling shutter RGB cameras that are time synchronized and share exposure and white balance settings. The plurality of 2D images 105 can represent an image frame. In an example implementation, the plurality of cameras may not capture depth. Therefore, the plurality of 2D images 105 may not include depth information. In an example implementation the 3D streaming pipeline 110 can be on a same device (e.g., a sending station) as the plurality of cameras. In this example implementation, as a frame(s) is captured, the plurality of 2D images 105 can be processed in-line by the 3D streaming pipeline 110.

In an example implementation the 3D streaming pipeline 110 can be on a different device (e.g., a server) than the plurality of cameras. In this example implementation, as a frame(s) is captured, the plurality of 2D images 105 can be compressed using, for example, the HEVC (h.265) standard at 25 Mbps per camera and then communicated to the server to be processed by the 3D streaming pipeline 110. In this implementation, the plurality of 2D images 105 can be decompressed and processed by the 3D streaming pipeline 110.

The mesh synthesis module 115 can be configured to synthesize or fuse the plurality of 2D images 105 into a 3D representation of a scene sometimes called a layered mesh (e.g., layered mesh 20 described in more detail below) and the render module 120 can be configured to render the layered mesh as a 3D image representation of a scene. In an example implementation, the layered mesh can represent the complete 3D scene based on the plurality of 2D images 105. In other words, the layered mesh has not been configured to render almost any particular viewpoint perspective (e.g., left-eye and right-eye) of a user viewing the playback device 125. Further, the layered mesh can be used to render any potential viewpoint perspective of a user viewing the playback device 125. Further, the layered mesh can be used to render any potential viewpoint perspective of a user viewing the playback device 125. In other words, the synthesized layered mesh can represent any view perspective corresponding to any head position such that, when displayed on the playback device 125, left eye and right eye images that are rendered based on the synthesized layered mesh can have a view perspective that can be modified with six degrees of freedom (DoF) based on the users view perspective and/or head position.

The render module 120 can be configured to render two images and generate two depth maps (e.g., one for each of the user's eyes viewing the playback device 125). The two images can be RGB and depth map views. In an example implementation, the playback device 125 can communicate a current or last viewpoint perspective and/or head pose of the user viewing the playback device 125. Therefore, the render module 120 can be configured to render the two images and generate the two depth maps (e.g., RGB and depth map views) based on the current or last viewpoint perspective and/or head pose of the user. The rendered images and generated depth maps can be streamed (e.g., communicated) to the playback device 125 at, for example, a 4K resolution and 30 fps.

In an example implementation, the playback device 125 can be configured to perform a last-second reprojection of the rendered images and generated depth maps using the latest viewpoint perspective and/or head pose of the user estimate before rendering to the display of the playback device 125. The reprojection can adjust for user movement (e.g., a change in viewpoint perspective and/or head pose) during the streaming process (e.g., due to system and/or streaming latency).

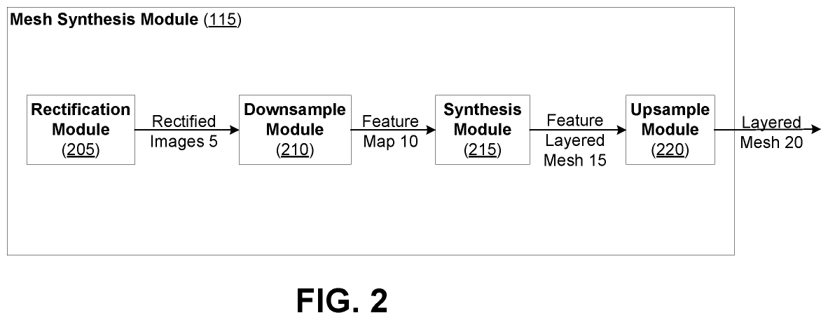

FIG. 2 illustrates a block diagram of a view synthesis system according to an example implementation. The view synthesis system can be configured to blend image weights and densities and reconstructs depth layers in the form of a layered mesh representation. The view synthesis system can be based on a Deep View algorithm. For example, the view synthesis system can be configured to generate a layered mesh output through a process of iterative refinement. As shown in FIG. 2, the mesh synthesis module 115 includes a rectification module 205, a downsample module 210, a synthesis module 215, and an upsample module 220.

The rectification module 205 can be configured to generate rectified images 5. In an example implementation, the rectification module 205 can be configured to reproject each of the images 105 to a layered mesh plane as the rectified images 5. In an example implementation, the layered mesh plane can be a near clipping plane. The rectification module 205 can be configured to decrease resolution of each of the images 105 during the reprojection of each of the images 105. The reprojection of each of the images 105 can ensure or help to ensure that image coordinates are consistent across each of the rectified images 5.

The downsample module 210 can be configured to downsample each of the rectified images 5 by, for example, eight times (8×) using, for example, a trained machine learning downsampling network. The machine learning downsampling network can be configured to generate low resolution feature maps 10 for each of the rectified images 5.

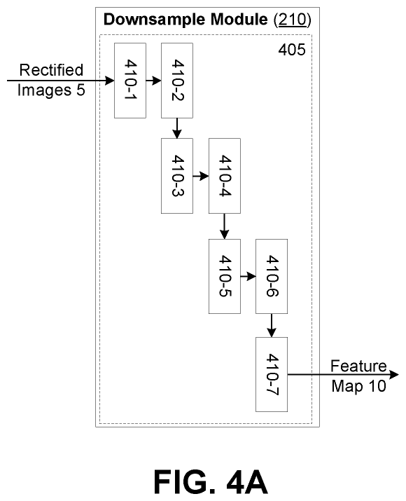

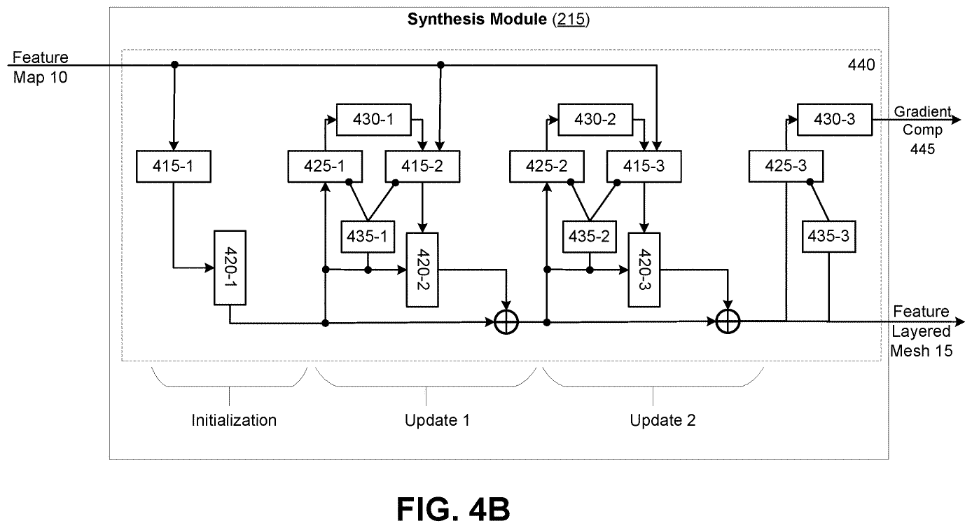

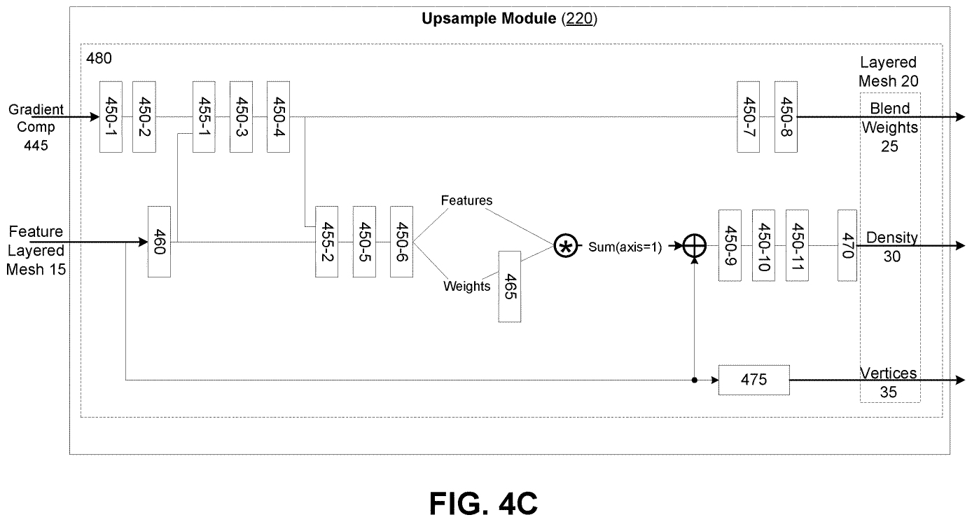

FIG. 4A illustrates a block diagram of an example machine learning downsampling network according to an example implementation as an example element (or implementation) of the downsample module 210. The machine learning downsampling network 405 can include a plurality of convolution layers 410-1, 410-2, 410-3, 410-4, 410-5, 410-6, 410-7. For example, the machine learning downsampling network 405 can include a series of strided convolutional layers. Therefore, the convolution layers 410-1, 410-2, 410-3, 410-4, 410-5, 410-6, 410-7 can be strided convolutional layers. Striding in a convolution layer indicates a number of pixels the filter matrix of the convolution layer moves across the input image. The stride length of a convolution layer indicates how many steps are taken when sliding the filter matrix across the image. In some implementations, the stride length of the convolution layers 410-1, 410-2, 410-3, 410-4, 410-5, 410-6, 410-7 can be one or two. For example, convolution layers 410-1, 410-3, 410-5, and 410-7 can have a stride length of one and convolution layers 410-2, 410-4, and 410-6 can have a stride length of two.

The plurality of convolution layers 410-1, 410-2, 410-3, 410-4, 410-5, 410-6, 410-7 can be configured to reduce the resolution of the rectified images 5. For example, the resolution of the rectified images 5 can be reduced by eight times (8×). For example, convolution layers 410-3, 410-4 can be configured to reduce the resolution of the rectified images 5 by two times (2×), convolution layers 410-5, 410-6 can be configured to reduce the resolution of the rectified images 5 by two times (2×), and convolution layers 410-7 can be configured to reduce the resolution of the rectified images 5 by two times (2×) for a total resolution reduction of eight times (8×). In some implementations, the convolution layers 410-1, 410-2, 410-3, 410-4, 410-5, 410-6, 410-7 can be configured to increase each of the rectified images 5 channel count from, for example, 4 to 32 channels.

Returning to FIG. 2, the synthesis module 215 can be configured to generate a feature layered mesh 15. The feature layered mesh 15 can be a low-resolution layered mesh. In an example implementation, the feature layered mesh 15 can include 288×184 pixels×16 layers. FIG. 4B illustrates a block diagram of an example machine learning view synthesis network according to an example implementation as an example element (or implementation) of the synthesis module 215.

As shown in FIG. 4B, in an example implementation, the feature layered mesh 15 layers can be initialized to have a flat geometry and project the feature map 10 onto these layers to generate a plane sweep volume (PSV). Then, according to an example implementation, an initialization network (e.g., images to layers transition 415-1 and neural network 420-1 (e.g., a convolutional neural network (CNN))) can be configured to compute an initial estimate of the feature layered mesh 15 (e.g., then output of neural network 420-1 or LayeredMesh) based on the PSV. At this point, the feature layered mesh 15 layers can include network features (with 32 channels). In an example implementation, the first 30 channels of the machine learning view synthesis network can include abstract network features (e.g., the features do not have any particular physical interpretation, therefore the network can be free to use features of the feature layered mesh 15 in any useful way). However, in an example implementation, the final two channels of the feature layered mesh 15 can be used by the machine learning view synthesis network to derive depth and density information. Accordingly, the machine learning view synthesis network can be configured to generate (or learn to generate) features for learning depth and density information.

The feature layered mesh 15 generated by the initialization network can be refined via two successive update steps. A first update step (Update 1) can include layers to images transition 425-1, images to layers transition 415-2, neural network 420-2 (e.g., a CNN), visibility components 430-1, and an activation block 435-1. A second update step (Update 2) can include layers to images transition 425-2, images to layers transition 415-3, neural network 420-2 (e.g., a CNN), visibility components 430-2, and an activation block 435-2. During each update step, the current feature layered mesh 15 can be projected back into the input feature map 10. In some implementations, the current feature layered mesh 15 can be compared to determine how well the current feature layered mesh 15 can approximate the real imagery captured by the input cameras. However, the feature layered mesh 15 that has been projected back into the input feature map 10 can be used in any useful process. In an example implementation, when projecting the features of the feature layered mesh 15 into the viewpoint of the input feature map 10, a geometry derived from the second to last depth channel in the layered mesh can be used. This channel can be activated (e.g., activation block 435-1, 435-2, 435-3) with a tanh nonlinearity, scaled by the layer width, and added to a set of depth anchors (e.g., the output of activation block 435-1, 435-2, 435-3) that are equally spaced in disparity. Constructing geometry using this technique can prevent feature layered mesh 15 layers from overlapping, because each layer can inhabit the layers own unique disparity band.

The layer geometry can then be used to warp from a layer space to a view space (and back again). While in view space the last channel (e.g., the density feature) of the feature layered mesh 15 can be used to perform compositing operations that can help communicate visibility information across the layers. These visibility components 430-1, 430-2, 430-3 can be used or help the update network because the visibility components 430-1, 430-2, 430-3 can reason about occlusions and understand across-layer dependencies. The visibility components 430-1, 430-2, 430-3 can be accumulated over and include a net transmittance. Accumulated over can include the reconstruction of the scene from behind the plane, and the net transmittance can be the soft occlusion mask for the plane.

The computation of visibility components 430-1, 430-2, 430-3 can improve the functioning of machine learning view synthesis network, because the computation of visibility components can be the time when information is communicated between layers. To complete the update step, the visibility components 430-1, 430-2, 430-3 can be warped from each of the input view spaces back to a central layered mesh representation and then these features can be input into the update network. The update network can be configured to generate a delta that can be added via a residual connection to the layered mesh computed in the previous iteration. This can iteratively (e.g., a plurality of update steps) generate the feature layered mesh 15 based on the feature map 10. In Addition, activation block 435-3, layer to images 425-3, and visibility components 430-3 together can generate gradient computations 445. Alternatively (or in addition), the layer to images 425-3 can calculate visibility components 430-3 (as the gradient computations 445) based on the feature layered mesh 15 and the depth calculated by the activation block 435-3. This reconstruct, check, and then refine strategy implemented in the update steps can be repeated several times, and strategy can function like an iterative optimization algorithm. Convergence to a high-quality solution can occur in a few (e.g., three) iterations.

Returning to FIG. 2, the upsample module 220 can be configured to generate layered mesh 20. In an example implementation, the upsample module 220 can be configured to increase the resolution of the feature layered mesh 15. In an example implementation, the upsample module 220 can be configured to increase a density 30 in resolution by, for example, eight times (8×). For example, the density 30 of the feature layered mesh 15 can be increased to a 1080p resolution. In an example implementation, the upsample module 220 can be configured to refine blend weights 25 of the feature layered mesh 15. However, the blend weight 25 and mesh vertices 35 of the layered mesh 20 can remain at a low resolution. Leaving the blend weights 25 and mesh vertices 35 at a low resolution can increase efficiency. For example, the final 3D image may not be sensitive to the resolution of blend weights 25 and mesh geometry. By contrast, the final 3D image can be sensitive to alpha and RGB resolution.

FIG. 4C illustrates a block diagram of an example machine learning upsampling network according to an example implementation as an example element (or implementation) of the upsample module 220. As shown in FIG. 4C, in an example implementation, the machine learning upsampling network 480 can use the feature layered mesh 15 computed by the view synthesis network 440 and a final set of visibility components (gradient computations 445), and then processes these using a series of convolutions 450-1, 450-2, 450-3, 450-4, 450-5, 450-6, 450-7, 450-8, 450-9, 450-10, and 450-11, concatenations 455-1, 455-2, and a squeeze and excitation network (including the features and weights, a softmax 465 with the multiplication and addition elements) to estimate a low-resolution blend weight 25, mesh vertex 35 positions, and higher resolution density 30 layers of the layered mesh 20. In some implementations, the convolutions 450-7, 450-8 can be referred to as a blend model and the convolutions 450-9, 450-10, 450-11 can be referred to as a density model. In an example implementation, the above-mentioned density 30 layers can be upsampled via a depth2space transform 470. In some implementations, the feature layered mesh 15 (e.g., a second to last channel of the feature layered mesh 15) can be activated and converted 475 to produce a tensor containing 3D mesh vertex 35 locations.

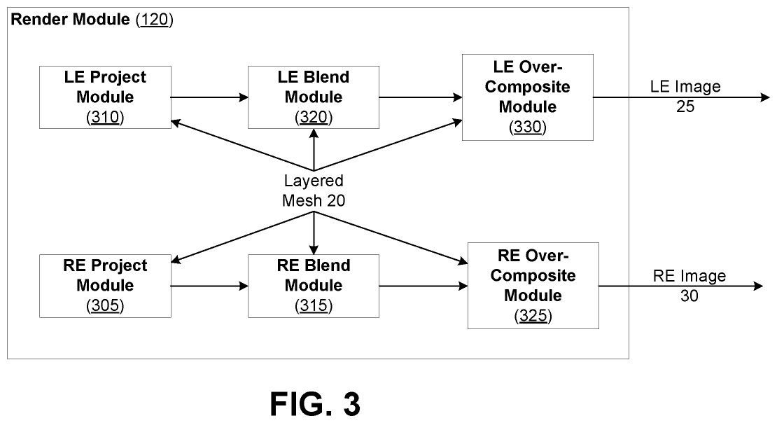

FIG. 3 illustrates a block diagram of a neural rendering system according to an example implementation. As shown in FIG. 3, the render module 120 can be configured to generate a left eye (LE) image 25 and a right eye (RE) image 30 based on the layered mesh 30. In an example implementation, the LE image 25 and RE image 30 can each be a 4k RGB plus depth image. As shown in FIG. 3, the render module 120 can include a RE project module 305, a LE project module 310, a RE blend module 315, a LE blend module 320, a RE over-composite module 325, and a LE over-composite module 330. In an example implementation, the layered mesh 20 can include 16 mesh layers each including an associated blend weight and density value. Further, the layered mesh 20 can be used to render any potential viewpoint perspective of a user viewing the playback device 125. In other words, the synthesized layered mesh can represent any view perspective corresponding to any head position such that, when displayed on the playback device 125, left eye and right eye images that are rendered based on the synthesized layered mesh can have a view perspective that can be modified with six degrees of freedom (DoF) based on the users view perspective and/or head position.

In an example implementation each mesh layer of the layered mesh 20 can be rasterized into an image space of the output view to be rendered. This process returns the intersection triangle index and barycentric coordinates for each pixel in the output view. In an example implementation, this information can be used to (1) look up a set of six blend weights (e.g., using barycentric interpolation of the mesh layer blend weights produced by the model), (2) look up a density value (e.g., using barycentric interpolation of the mesh layer densities produced by the model), and (3) compute 3D coordinates for the point of intersection. These 3D coordinates can be projected back into the image planes of the original high resolution input views to determine (e.g., using bilinear interpolation) an RGB value from each input image.

In an example implementation, the blend weights can be activated using a softmax non-linearity and then used to compute a simple weighted average of the RGB values from the input views. The density value can be activated via a softplus non-linearity and converted to an alpha value. In an example implementation, rasterization of one layer to an output view can generate an RGB plus alpha value for each pixel in a layer.

This sequence of rasterization, projection and sampling steps includes the signal flow shown in FIG. 3. For example, the signal flow includes projecting the input images onto the mesh geometry (the RE project module 305 and the LE project module 310), blend the mesh together using the blend weights, combine with alpha values from the layer, and then project the result into the output view (the RE blend module 315 and the LE blend module 320).

In an example implementation, the non-linear activations can include activating after resampling. In other words, the non-linear activations can include projecting the input images, blend weights, and densities into the output viewpoint. When the network is trained through a differentiable version of the rendering process described above, it can learn to expect these activations to occur in a higher resolution space, and the network can actually learn to take advantage of post-interpolation activations to produce sharper, higher resolution results even when working with relatively low-resolution blend weights and alpha densities. In an example implementation, activating after resampling can be called deferred rendering or deferred sampling of the layered mesh. Deferred rendering or deferred sampling of the layered mesh can help achieve the high quality 4 k outputs, even though the layered mesh contains 1080p densities and low-resolution (e.g., 135×240 pixel) geometry and blend weights.

In an example implementation, rasterization can be repeated for each of the 16 mesh layers of the layered mesh 20, and then the resulting RGB plus alpha layers can be rendered using alpha compositing to produce a final RGB image for a particular output viewpoint (the RE over-composite module 325 and the LE over-composite module 330). In an example implementation, the RE over-composite module 325 and the LE over-composite module 330 can be configured to generate a depth channel by replacing the RGB in each layer with that layer's disparity, and then compositing disparity plus alpha layers.

In an example implementation, the deferred rendering or deferred sampling technique has the advantage of decoupling the resolutions of the input views, the network outputs, and the final RGB plus depth rendered result. This is advantageous because the decoupling can allow tuning the resolution of each component separately, which is useful for trading off quality against performance. For example, the speed of the RGB plus depth renderer can be increased by outputting RGB plus depth images at 1440p while using 4 k inputs.

The layered mesh 20 described above can be used to represent the 3D structure of the scene. In addition, layered mesh provides a mesh representation that can be rasterized to produce the RGB plus depth views used to stream to the playback device 125. Layered meshes can be related to multi-plane images (MPIs). With both MPIs and layered meshes, a viewpoint can be rendered via a combination of perspective projection and alpha compositing. Mesh layers can occupy disparity bands that, like MPI planes, can be equally spaced in disparity (1/z) space. Views can be rendered by first projecting layers into the output viewpoint and then alpha compositing from back to front. However, unlike the flat plane geometry of the MPI, mesh layers can have network-produced geometry that molds itself to the shape of the object being reconstructed. This allows layered meshes to achieve similar quality to an MPI but with far fewer layers. Using layered meshes layers a 30 fps at high resolution can be achieved, as layered meshes enables an efficient (10× faster than with MPIs) way to perform learned upsampling and rendering.

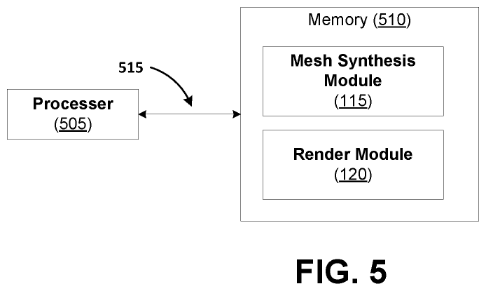

FIG. 5 illustrates a block diagram of a system according to an example implementation. In the example of FIG. 5, the system (e.g., the wearable device 300, an augmented reality system, a virtual reality system, a companion device, and/or the like) can include a computing system or at least one computing device and should be understood to represent virtually any computing device configured to perform the techniques described herein. As such, the device may be understood to include various components which may be utilized to implement the techniques described herein, or different or future versions thereof. By way of example, the system can include a processor 505 and a memory 510 (e.g., a non-transitory computer readable memory). The processor 505 and the memory 510 can be coupled (e.g., communicatively coupled) by a bus 515.

The processor 505 may be utilized to execute instructions stored on the at least one memory 510. Therefore, the processor 505 can implement the various features and functions described herein, or additional or alternative features and functions. The processor 505 and the at least one memory 510 may be utilized for various other purposes. For example, the at least one memory 510 may represent an example of various types of memory and related hardware and software which may be used to implement any one of the modules described herein.

The at least one memory 510 may be configured to store data and/or information associated with the device. The at least one memory 510 may be a shared resource. Therefore, the at least one memory 510 may be configured to store data and/or information associated with other elements (e.g., image/video processing or wired/wireless communication) within the larger system. Together, the processor 505 and the at least one memory 510 may be utilized to implement the techniques described herein. As such, the techniques described herein can be implemented as code segments (e.g., software) stored on the memory 510 and executed by the processor 505. Accordingly, the memory 510 can include any combination of mesh synthesis module 115 and the render module 120. The example implementation shown in FIG. 5 is only one example hardware configuration. In other implementations operations can be shared between computing devices.

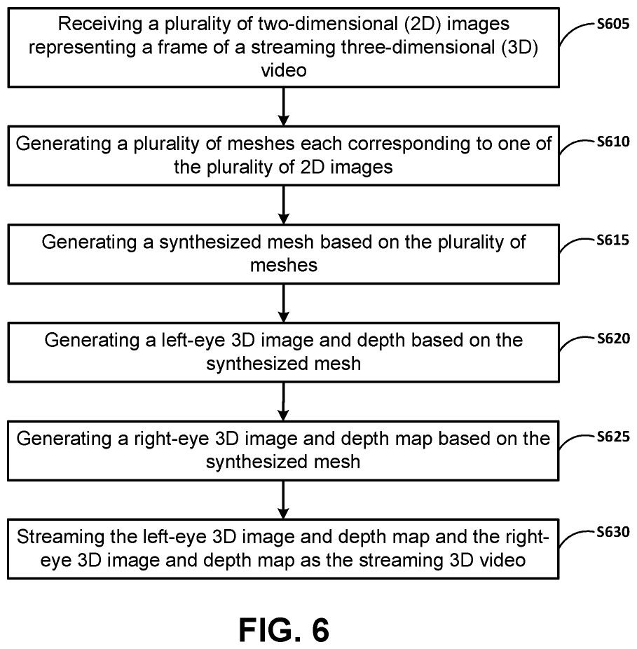

Example 1. FIG. 6 illustrates a block diagram of a method according to an example implementation. As shown in FIG. 6, in step S605 a plurality of two-dimensional (2D) images representing a frame of a streaming three-dimensional (3D) video is received. In step S610 a plurality of meshes corresponding to the plurality of 2D images is generated. In step S615 a synthesized mesh is generated based on the plurality of meshes. In step S620 a left-eye 3D image and depth is generated based on the synthesized mesh. In step S625 a right-eye 3D image and depth map is generated based on the synthesized mesh. In an example implantation, the left-eye 3D image and depth map and the right-eye 3D image and depth map have a viewpoint perspective based on a receiver of the streaming 3D video. In step S630 the left-eye 3D image and depth map and the right-eye 3D image and depth map as the streaming 3D video are streamed. Here, a single 2D image can represent a single frame. The term “frame” can be understood as a single image that, when played in sequence with the other frames of the video, creates motion on the playback surface. A mesh of the plurality of meshes can be generated for each one of the plurality of 2D images. The step of Generating S615 can refer to synthesize or fuse the plurality of 2D images into a 3D representation of a scene. The viewpoint perspective can be the perspective of a user streaming the 3D images on a 3D playback device.

Example 2. The method of Example 1, wherein the plurality of 2D images can have a different viewpoint perspective as compared to the viewpoint perspective based on a receiver of the frame of the streaming 3D video.

Example 3. The method of Example 1, wherein the generating of the plurality of meshes can includes downsampling the plurality of 2D images to generate a plurality of feature maps corresponding to one of the plurality of 2D images and generating the plurality of meshes based on the plurality of feature maps.

Example 4. The method of Example 3, wherein the generating of the left-eye 3D image and depth map and the generating of the right-eye 3D image and depth map can include synthesizing the plurality of feature maps as a feature layered mesh, upsampling the feature layered mesh as a layered mesh, and generating the left-eye 3D image and depth map and generating the right-eye 3D image and depth map based on the layered mesh.

Example 5. The method of Example 4, wherein the synthesizing of the plurality of feature maps can include initializing the plurality of feature maps to have a flat geometry and projecting the plurality of feature maps to generate a plane sweep volume (PSV).

Example 6. The method of Example 4, wherein the feature layered mesh can include a plurality of channels, a first subset of the plurality of channels can include abstract network features, and a second subset of the plurality of channels can include depth and density information.

Example 7. The method of Example 4, wherein the synthesizing of the plurality of feature maps can include generating visibility components to identify occlusions and cross-layer dependencies.

Example 8. The method of Example 4, wherein the synthesizing of the plurality of feature maps can include projecting the feature layered mesh onto at least one of the plurality of feature maps to determine how well the feature layered mesh approximates at least one of the plurality of 2D images. Alternatively, or additionally, the synthesizing of the plurality of feature maps can include projecting the feature layered mesh onto at least one of the plurality of feature maps and comparing to at least one of the plurality of 2D images to determine an approximation of the feature layered mesh to the at least one of the plurality of 2D images. Alternatively, or additionally, the synthesizing of the plurality of feature maps can include projecting the feature layered mesh onto at least one of the plurality of feature maps and comparing the result to at least one of the plurality of 2D images to determine whether a difference between the feature layered mesh to the at least one of the plurality of 2D images meets a criteria. The criteria can include a per pixel delta threshold, a region of pixels average delta threshold, an object pixel delta threshold, a total loss threshold, a peak signal-to-noise ratio (PSNR), and the like.

Example 9. The method of Example 1 can further include streaming the right-eye 3D image and depth map and the left-eye 3D image and depth map as the frame of the streaming 3D video.

Example 10. A method can include any combination of one or more of Example 1 to Example 9.

Example 11. A non-transitory computer-readable storage medium comprising instructions stored thereon that, when executed by at least one processor, are configured to cause a computing system to perform the method of any of Examples 1-10.

Example 12. An apparatus comprising means for performing the method of any of Examples 1-10.

Example 13. An apparatus comprising at least one processor and at least one memory including computer program code, the at least one memory and the computer program code configured to, with the at least one processor, cause the apparatus at least to perform the method of any of Examples 1-10.

### Density and Alpha

Example implementations can use a quantity called density that is related to alpha via alpha=(1.0−jnp.exp(−density)). Density can be inspired by fog rendering equations and can work in an intuitive fashion where a layer with high density is mostly opaque and a layer with low density is mostly transparent. However, while alpha is linearly related to transparency, density is logarithmically related to transparency. CNNs may more easily reason about density as compared to alpha and using density can help to simplify compositing and gradient computations (e.g., gradient computations 445), which leads to a more efficient and faster network. Here is a simple network that computes density using a series of 2D convolutions.

class DensityModel(nn.Module):
@nn.compact
def _{——}call_{——}(self, x):
x = jax.nn.elu(nn.Conv(features=32, kernel_size=(3,3))(x))
x = jax.nn.elu(nn.Conv(features=32, kernel_size=(3,3))(x))
return jax.nn.softplus(nn.Conv(features=1, kernel_size=(3,3))(x))

In the last layer of the network a jax.nn.softplus non-linearity that forces the density to be strictly positive can be used. Therefore, when alpha=exp(−density) is computed, the values will fall between [0.0, 1.0]. Then RGB plus density can be combined and passed as the output of the network. When needed, functions for performing over-compositing directly with rgb_density can include,

rgb, density = jax_utils.subdivide(rgb_density, (3, 1), axis=−1)
overed_image = composite.density_over(rgb, density, premultiply=True)

And if alpha is needed rather than density, density can be converted via,

$$rgba = composite . rgb\_density \_to \_rgba ( rgb , density )$$

### Depth Normalized Coordinates (DNC) Space

Differentiable renderers can be optimized to render densely connected 3D mesh geometries. The acceleration structure used in this rendering code assumes this geometry is associated with a defined viewing frustum and a near and far clipping plane. The renderer natively supports the notion of layers of geometry inside this viewing frustum, and while each layer is ray traced separately, many functions assume that the layers contain RGB plus alpha textures and that they composite in a fixed back to front order to produce a final rendered image.

An MpiOptions class can be used to describe the rendering viewpoint for the ray tracing code. This class established the field of view, near and far plane, number of depth layers, and texture resolution for the viewport. Only specifying one of the horz_fov_degress or vert_fov_degrees can cause the other to be computed automatically based on the aspect ratio of the texture width and height.

viewport_options = MpiOptions(
height=180,
width=320,
num_layers = 8,
near_depth = 0.8,
far_depth=100.0,
horz_fov_degrees=130,
vert_fov_degrees=104)

This viewport sets up a relationship that will project 3D points in viewport space to pixel coordinates in the layer textures. It operates very similar to a perspective camera model in computer vision, and that relationship can be made explicit by making it possible to request the viewport_options.intrinsics to get a 3×3 transform that converts a 3D coordinate in *viewport space* to a pixel coordinate in the *viewport texture space* via,

$$( \begin{matrix}u \\ v \\ w\end{matrix} ) = ( \begin{matrix}\frac{h / 2}{tan ( {α}_{y} / 2 )} & 0 & \frac{h}{2} \\ 0 & \frac{w / 2}{tan ( {α}_{z} / 2 )} & \frac{w}{2} \\ 0 & 0 & 1\end{matrix} ) \cdot ( \begin{matrix}{x}_{v} \\ {y}_{v} \\ {z}_{v}\end{matrix} ) \cdot$$

Here, $h$ and $w$ are the texture height and width in pixels, and $\alpha_x$ and $\alpha_y$ are the horizontal and vertical fields of view of the viewport. The input coordinates $(x_v, y_v, z_v)$ are in *viewport_space*, which is defined such that $+y$ is along the principal ray at the center looking into the viewport, $+z$ is pointing straight down, and $+x$ completes a right handed coordinate system. The output coordinates are homogeneous, and must be normalized; hence a ray passing through $(x_v, y_v, z_v)$ will intersect the texture at pixel coordinates $(\frac {u} {w}, \frac {v} {w})$. A set of extrinsics can be defined for the viewpoint, w_f_viewport, that transforms from *viewport space* to a desired world coordinates $(x_w, y_w, z_w)$ via translation, scaling, and rotation.

The viewport intrinsics in the previous section defines a projection from 3D to 2D. However, when working with depth layers it is helpful to keep track of the depth of the point being project so that it is possible to reverse the transform and go from texture coordinates (plus depth) to a 3D point in *viewport space*. This can be done by augmenting the intrinsics slightly and explicitly defining how the projective transform maps a 3D point to a *normalized* displacement $d$:

$$( \begin{matrix}u \\ v \\ d \\ w\end{matrix} ) = ( \begin{matrix}\frac{h / 2}{tan ( {α}_{y} / 2 )} & 0 & 0 & \frac{h}{2} \\ 0 & \frac{w / 2}{tan ( {α}_{z} / 2 )} & 0 & \frac{w}{2} \\ 0 & 0 & 1 & 0 \\ 0 & 0 & 0 & 1\end{matrix} ) \cdot ( \begin{matrix}1 & 0 & 0 & 0 \\ 0 & 1 & 0 & 0 \\ 0 & 0 & - \frac{{d}_{n}}{{d}_{f} - {d}_{n}} & \frac{{d}_{f} {d}_{n}}{{d}_{f} - {d}_{n}} \\ 0 & 0 & 1 & 0\end{matrix} ) \cdot ( \begin{matrix}{x}_{v} \\ {y}_{v} \\ {z}_{v} \\ 1\end{matrix} )$$

The matrix on the left is a slightly augmented version of the viewport intrinsics matrix. The matrix on the right captures the geometry of a perspective projection, where a point $z_v$ is projected to a normalized displacement $d$. The relationship between the two is a function of $d_n$ and $d_f$, which are the $z$ depths of the near and far clipping planes. Constructing the completdnc_f_viewport transform (the product of these two matrices) is accomplished by calling this function:

dnc_f_mpi =
transforms.dnc_f_mpi_matrix(viewport_options.intrinsics,
viewport_options.near_depth,
viewport_options.far_depth)

One thing to note about the dnc_f_viewport transform is that the dnc “depth” values do *not* represent distance along a ray originating at the viewport center of projection. Rather, they are related simply to the $z_1$ values in layer coordinate space.

### Converting DNC Depths to a Vertex Grid

One aspect of the DNC space is that the resulting depth values $d$ are normalized such that a value of 0.0 represents the far clipping depth and 1.0 represents the near clipping depth. Values in between linearly interpolate in $1/z$, which means that $d$ behaves like a normalized disparity value that smoothly interpolates over the depth range in the viewing frustum in what will appear to the viewer like equal increments once the image is projected and rendered near the frustum's center of projection.

The space can be constructed in this fashion is that a neural network can output a feature activated with a jax.nn. tan h( ) function, and then interpreted as a DNC depth value $d$ since it will be scaled between 0.0 and 1.0. This gives the network a very natural, well-behaved way of describing depths that scale linearly once projected into target viewpoint (or viewpoints). Of course, to render the geometry described by a series of DNC depth layers, it is helpful to be able to convert it to a traditional triangle mesh. A vertex_grid_utils.vertex grid_from_dnc_depths( ) can be used for doing this. The example below also shows how to compose the dnc_f_viewport matrix with a w_f_viewport transform so that the resulting triangle mesh appears in world coordinates rather than viewport coordinates.

# Define a viewport to world transform. Use the identity for now, but this could
# be any coordinate transform related viewport space to world space.
w_f_viewport = jnp.eye(4)
w_f_dnc = jnp.matmul(w_f_viewport, jnp.linalg.inv(dnc_f_viewport))
# Contruct equally spaced DNC “depth” values and then broadcast from a vector of
# [D] depths to [D, H, W, 1] tensor containing DNC “layers” like those that
# might be produced in a tanh( ) activated feature from a network.
dnc_depths = jnp.linspace(
start=0.0,
stop=1.0,
num=viewport_options.num_layers,
endpoint=True,
dtype=jnp.float32)
dnc_depths = jnp.broadcast_to(
jnp.expand_dims(dnc_depths, (1, 2, 3)),
(viewport_options.num_layers, viewport_options.height, viewport_options.width,
1))
# Convert the dnc depths to an xyz triangle mesh.
vertex_grid_w = vertex_grid_utils.vertex_grid_from_dnc_depths(w_f_dnc, dnc_depths)
print(f‘dnc_depths shape: {dnc_depths.shape}’)
print(f‘vertex_grid_w shape: {vertex_grid_w.shape}’)

In this example, a series of planar layers that are evenly distributed in DNC depth space can be constructed. This results in a set of planes distributed in equal $1/z$ increments in world space, similar to how MPI planes can be constructed. Notice also here that the final transform converts a single DNC depth value to a 3D $(x_w, y_w, z_w)$ coordinate. The lateral coordinates in the DNC space are implied by the pixel location in the second and third dimension of the dnc_depths tensor, but these lateral coordinates are made explicit in the vertex grid_w. Another thing that is implied in both dnc_depths and vertex grid_w is the connectivity of the mesh. Both represent a densely connected mesh where groups of four neighboring coordinates are used to form two triangles in the mesh. The term vertex grid can be used to describe a mesh whose topology is implied via the shape and structure of the tensor containing only the $(x_w, y_w, z_w)$ of its vertices.

Example implementations can include a non-transitory computer-readable storage medium comprising instructions stored thereon that, when executed by at least one processor, are configured to cause a computing system to perform any of the methods described above. Example implementations can include an apparatus including means for performing any of the methods described above. Example implementations can include an apparatus including at least one processor and at least one memory including computer program code, the at least one memory and the computer program code configured to, with the at least one processor, cause the apparatus at least to perform any of the methods described above.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

While example embodiments may include various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

Some of the above example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example embodiments. Example embodiments, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term and/or includes any and all combinations of one or more of the associated listed items.

It will be understood that when an element is referred to as being connected or coupled to another element, it can be directly connected or coupled to the other element or intervening elements may be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular embodiments only and is not intended to be limiting of example embodiments. As used herein, the singular forms a, an and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example embodiments and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative embodiments, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example embodiments are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example embodiments not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or embodiments herein disclosed irrespective of whether or not that particular combination has been specifically enumerated in the accompanying claims at this time.

1. A method comprising:
receiving a plurality of two-dimensional (2D) images representing a frame of a streaming three-dimensional (3D) video;
generating a plurality of meshes corresponding to the plurality of 2D images;
generating a synthesized mesh based on the plurality of meshes;
generating a left-eye 3D image and depth based on the synthesized mesh; and
generating a right-eye 3D image and depth map based on the synthesized mesh, the left-eye 3D image and depth map and the right-eye 3D image and depth map having a viewpoint perspective based on a receiver of the streaming 3D video.

2. The method of claim 1, wherein the plurality of 2D images has a different viewpoint perspective as compared to the viewpoint perspective based on a receiver of the frame of the streaming 3D video.

3. The method of claim 1, wherein the generating of the plurality of meshes includes:
downsampling the plurality of 2D images to generate a plurality of feature maps corresponding to one of the plurality of 2D images, and
generating the plurality of meshes based on the plurality of feature maps.

4. The method of claim 3, wherein the generating of the left-eye 3D image and depth map and the generating of the right-eye 3D image and depth map include:
synthesizing the plurality of feature maps as a feature layered mesh,
upsampling the feature layered mesh as a layered mesh, and
generating the left-eye 3D image and depth map and generating the right-eye 3D image and depth map based on the layered mesh.

5. The method of claim 4, wherein the synthesizing of the plurality of feature maps includes initializing the plurality of feature maps to have a flat geometry and projecting the plurality of feature maps to generate a plane sweep volume (PSV).

6. The method of claim 4, wherein
the feature layered mesh includes a plurality of channels,
a first subset of the plurality of channels include abstract network features, and
a second subset of the plurality of channels include depth and density information.

7. The method of claim 4, wherein the synthesizing of the plurality of feature maps includes generating visibility components to identify occlusions and cross-layer dependencies.

8. The method of claim 4, wherein the synthesizing of the plurality of feature maps includes projecting the feature layered mesh onto at least one of the plurality of feature maps to determine how well the feature layered mesh approximates at least one of the plurality of 2D images.

9. The method of claim 1, further comprising streaming the right-eye 3D image and depth map and the left-eye 3D image and depth map as the frame of the streaming 3D video.

10. A non-transitory computer-readable storage medium comprising instructions stored thereon that, when executed by at least one processor, are configured to cause a computing system to:
receive a plurality of two-dimensional (2D) images representing a frame of a streaming three-dimensional (3D) video;
generate a plurality of meshes corresponding to the plurality of 2D images;
generate a synthesized mesh based on the plurality of meshes;
generate a left-eye 3D image and depth based on the synthesized mesh; and
generate a right-eye 3D image and depth map based on the synthesized mesh, the left-eye 3D image and depth map and the right-eye 3D image and depth map having a viewpoint perspective based on a receiver of the streaming 3D video.

11-12. (canceled)

13. The non-transitory computer-readable storage medium of claim 10, wherein the plurality of 2D images has a different viewpoint perspective as compared to the viewpoint perspective based on a receiver of the frame of the streaming 3D video.

14. The non-transitory computer-readable storage medium of claim 10, wherein the generating of the plurality of meshes includes:
downsampling the plurality of 2D images to generate a plurality of feature maps corresponding to one of the plurality of 2D images, and
generating the plurality of meshes based on the plurality of feature maps.

15. The non-transitory computer-readable storage medium of claim 14, wherein the generating of the left-eye 3D image and depth map and the generating of the right-eye 3D image and depth map include:
synthesizing the plurality of feature maps as a feature layered mesh,
upsampling the feature layered mesh as a layered mesh, and
generating the left-eye 3D image and depth map and generating the right-eye 3D image and depth map based on the layered mesh.

16. The non-transitory computer-readable storage medium of claim 15, wherein the synthesizing of the plurality of feature maps includes initializing the plurality of feature maps to have a flat geometry and projecting the plurality of feature maps to generate a plane sweep volume (PSV).

17. The non-transitory computer-readable storage medium of claim 15, wherein
the feature layered mesh includes a plurality of channels,
a first subset of the plurality of channels include abstract network features, and
a second subset of the plurality of channels include depth and density information.

18. The non-transitory computer-readable storage medium of claim 15, wherein the synthesizing of the plurality of feature maps includes generating visibility components to identify occlusions and cross-layer dependencies.

19. The non-transitory computer-readable storage medium of claim 14, wherein the synthesizing of the plurality of feature maps includes projecting the feature layered mesh onto at least one of the plurality of feature maps to determine how well the feature layered mesh approximates at least one of the plurality of 2D images.

20. The non-transitory computer-readable storage medium of claim 10, further comprising streaming the right-eye 3D image and depth map and the left-eye 3D image and depth map as the frame of the streaming 3D video.

21. An apparatus comprising:
at least one processor; and
at least one memory including computer program code;
the at least one memory and the computer program code configured to, with the at least one processor, cause the apparatus to:
receive a plurality of two-dimensional (2D) images representing a frame of a streaming three-dimensional (3D) video;
generate a plurality of meshes corresponding to the plurality of 2D images;
generate a synthesized mesh based on the plurality of meshes;
generate a left-eye 3D image and depth based on the synthesized mesh; and
generate a right-eye 3D image and depth map based on the synthesized mesh, the left-eye 3D image and depth map and the right-eye 3D image and depth map having a viewpoint perspective based on a receiver of the streaming 3D video.

22. The apparatus of claim 21, wherein
the generating of the plurality of meshes includes:
downsampling the plurality of 2D images to generate a plurality of feature maps corresponding to one of the plurality of 2D images, and
generating the plurality of meshes based on the plurality of feature maps; and
the generating of the left-eye 3D image and depth map and the generating of the right-eye 3D image and depth map includes:
synthesizing the plurality of feature maps as a feature layered mesh,
upsampling the feature layered mesh as a layered mesh, and
generating the left-eye 3D image and depth map and generating the right-eye 3D image and depth map based on the layered mesh.
